(19) United States
(12) Patent Application Publication
(10) Pub. No.: US 2009/0302506 A1
(43) Pub. Date: Dec. 10, 2009

(54) Ultra Water Repellent Film Manufacturing Equipment and Method

(76) Inventors: Jong Joo Rha, Changwon-si (KR); Gun Hwan Lee, Pyungtaek-si (KR); Kyung Hyun Hwang, Seoul (KR); Doo Sun Choi, Yusong-gu (KR)

Correspondence Address: SALIWANCHIK LLOYD & SALIWANCHIK;A PROFESSIONAL ASSOCIATION, PO Box 142950, GAINESVILLE, FL, 32614, US

(21) Appl. No.: 12/340,242

(22) Filed: Dec. 19, 2008

(30) Foreign Application Priority Data
Jun. 5, 2008 (KR) 10-2008-0052850

(51) Int. Cl. B29C 35/10; B28B 13/02

(52) U.S. Cl. 264/495; 425/224

(57) ABSTRACT

Provided are ultra water repellent film manufacturing equipment capable of continuous manufacturing of an ultra water repellent film through casting and separating a hydrophilic or hydrophobic polymer on an outer surface of a rotating belt, and an ultra water repellent film manufacturing method using the equipment. The equipment includes the rotating belt wound around rollers to continuously rotate, a polymer supplying member (120) containing a liquid polymer (M) to supply onto the rotating belt (110), a thickness controlling member (130) for controlling the supplied liquid polymer in thickness, a polymer drying member (140) for drying the liquid polymer controlled in thickness, a film separating member (150) for separating an ultra water repellent film (F) from the rotating belt, a rotating belt cleaning member (160) for cleaning an outer surface of the rotating belt after film separation, and a surface reforming member (170) for reforming the outer surface of the cleaned rotating belt.

### CROSS-REFERENCE TO RELATED APPLICATIONS

The present application claims priority under 35 U.S.C. 119 and 35 U.S.C. 365 to Korean Patent Application No. 10-2008-0052850 filed Jun. 5, 2008, which is hereby incorporated by reference in its entirety.

### BACKGROUND

The present invention relates to ultra water repellent film manufacturing equipment capable of continuous manufacturing of ultra water repellent film through casting and separating a hydrophilic or hydrophobic polymer on an outer surface of a rotating belt, and an ultra water repellent film manufacturing method using the equipment.

Water repellency can be said to be similar to hydrophobia (that has low affinity to water), and can be observed in everyday life. A good example of water repellency is the lotus flower, which induces water droplets that fall onto its petals to slide off, so that it does not become wet.

This phenomenon is employed for self-cleaning, by using water to remove impurities that collect on the surfaces of the lotus flower petals. Careful scrutiny of the phenomenon by scientists has revealed that projections of several to several tens of micrometers (μm) are formed on the surfaces of lotus petals, and projections of several tens to several hundreds of nanometers (nm) are further distributed on the surfaces of the larger projections. It was also discovered that these projections have a contact angle with respect to water of 140° or greater.

For comparison, air has a 180° contact angle with respect to water.

In the 1930s, scientific research was begun on this self-cleaning ability and the characteristic of preventing contaminants from easily attaching to the surface, and research on water repellent surfaces continues to this day.

As part of the above research, Korean Laid-open Patent No. 1996-0033562 discloses a hydrophobic coating method for silicon rubber and a hydrophobic coating material, entitled ‘Process of Drainage Coating’.

To briefly describe this invention, the surface of silicon rubber is modified to a hydrophilic rubber surface by activating and reforming the surface through plasma etching, treating the modified surface with plasma (a material for increasing adhesiveness), and then applying a hydrophobic polyurethane coating to develop a thin film silicon rubber surface having superb abrasion resistance, printability, and anti-skid properties and good tactility.

However, in the above-configured related art, the following limitations exist.

Specifically, a processing object is given hydrophobic properties through performing multiple processes including activating the surface of the processing object through plasma etching, and plasma treating the activated processed surface and applying a polyurethane coating thereon. In the polyurethane coating application process, a manifest difficulty in achieving a uniform coating thickness is problematic.

Also, because there is a maximum size restriction imposed on processing objects to which the above method can be applied, the method is unsuitable for hydrophobic treatment of large-sized processing objects, due to increased defect incidence.

Furthermore, even when a processing object is formed of a hydrophobic material, a polyurethane coating must still be applied, thereby raising manufacturing cost and lowering cost competitiveness.

### BRIEF SUMMARY

Embodiments provide ultra water repellent film manufacturing equipment capable of manufacturing ultra water repellent film through casting a hydrophilic or hydrophobic liquid polymer on an uneven surface of a rotating belt and then separating the cast film.

Embodiments also provide an ultra water repellent film manufacturing method using ultra water repellent film manufacturing equipment capable of continuous manufacturing of an ultra water repellent film having a large surface area through continuous rotation of an uneven surface of a rotating belt.

In one embodiment, equipment for manufacturing ultra water repellent film, includes: a rotating belt wound around outer peripheries of a plurality of rollers to continuously rotate; a polymer supplying member containing a liquid polymer to supply onto an upper surface of the rotating belt; a thickness controlling member for controlling a thickness of the liquid polymer supplied onto the upper surface of the rotating belt; a polymer drying member for drying the liquid polymer controlled in thickness; a film separating member for separating an ultra water repellent film, formed through drying by the polymer drying member, from the rotating belt; a rotating belt cleaning member for cleaning an outer surface of the rotating belt from which the ultra water repellent film has been separated; and a surface reforming member for reforming the outer surface of the cleaned rotating belt.

The outer surface of the rotating belt may be subjected to one or more of metal plating and plasma treatment and made into an uneven surface.

The polymer drying member may be configured to apply heat to or radiate ultraviolet (UV) rays onto the liquid polymer.

The rotating belt cleaning member may be configured to clean residual contaminants of polymer material from the outer surface of the rotating belt with plasma or solvent.

The surface reforming member may generate plasma under atmospheric pressure and supply the plasma onto the upper surface of the rotating belt.

The equipment may further include a hydrophobic member discharger provided between the polymer drying member and the film separating member, the hydrophobic member discharger using plasma to discharge a hydrophobic member on a surface of the ultra water repellent film when the liquid polymer is a hydrophilic member.

In another embodiment, a method for manufacturing ultra water repellent film using equipment for manufacturing ultra water repellent film, the method including: initializing rotation of a rotating belt having an uneven surface formed thereon; supplying liquid polymer onto an upper surface of the rotating belt; controlling a thickness of the liquid polymer supplied onto the upper surface of the rotating belt; drying the liquid polymer that has been controlled in thickness in the controlling of the thickness; separating an ultra water repellent film, formed from the drying of the liquid polymer, from the rotating belt; cleaning by removing contaminants adhered to an outer surface of the rotating belt from which the ultra water repellent film has been separated; and reforming the outer surface of the rotating belt through generating and supplying plasma thereon.

The drying of the liquid polymer may include hardening the liquid polymer by applying heat thereto or radiating ultraviolet (UV) rays thereon.

The cleaning of the rotating belt may include removing contaminants there from by generating and supplying plasma onto the rotating belt or passing the rotating belt through solvent.

The method may further include discharging a hydrophobic member between the drying of the liquid polymer and the separating of the ultra water repellent film, the discharging of the hydrophobic member using plasma under atmospheric pressure to discharge the hydrophobic member on a surface of a film having undergone the drying of the liquid polymer.

The details of one or more embodiments are set forth in the accompanying drawings and the description below. Other features will be apparent from the description and drawings, and from the claims.

### BRIEF DESCRIPTION OF THE DRAWINGS

FIG. 1 is a schematic configurative view of ultra water repellent film manufacturing equipment according to the present disclosure.

FIG. 2 is a flowchart of an ultra water repellent film manufacturing method using ultra water repellent film manufacturing equipment according to the present disclosure.

FIG. 3 is an enlarged view of an outer surface of a rotating belt (that is a component of ultra water repellent film manufacturing equipment) after being roughened with metal plating according to the present disclosure.

FIG. 4 is an enlarged view of a surface of a separated ultra water repellent film after being printed on the rotating belt surface in FIG. 3.

FIG. 5 is an enlarged view of the surface of an ultra water repellent film after being cast on an outer surface of a rotating belt (that is a component of ultra water repellent film manufacturing equipment) which has been roughened with metal plating and plasma according to the present disclosure.

FIG. 6 is an enlarged view of a surface of an ultra water repellent film manufactured according to an ultra water repellent film manufacturing method that uses ultra water repellent film manufacturing equipment according to the present disclosure.

FIG. 7 is a view showing contact angles of an uneven surface and a flat surface of an ultra water repellent film with respect to water.

### DETAILED DESCRIPTION

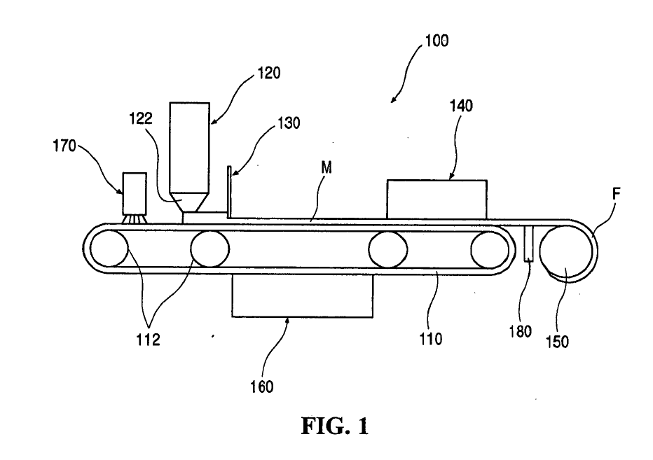

A description of the configuration of ultra water repellent film manufacturing equipment according to the present disclosure will be provided below with reference to FIG. 1.

FIG. 1 is a schematic configurative view of ultra water repellent film manufacturing equipment according to the present disclosure.

As shown in FIG. 1, ultra water repellent film manufacturing equipment 100 includes a rotating belt 110 wound around outer peripheries of a plurality of rollers 112 to continuously rotate, a polymer supplying member 120 containing a liquid polymer (M) to supply onto an upper surface of the rotating belt 110, a thickness controlling member 130 for controlling a thickness of the liquid polymer (M) supplied to onto the upper surface of the rotating belt 110, a polymer drying member 140 for drying the liquid polymer (M) controlled in thickness, a film separating member 150 for separating an ultra water repellent film (F) formed through drying by the polymer drying member 140 from the rotating belt 110, a rotating belt cleaning member 160 for cleaning an outer surface of the rotating belt 110 from which the ultra water repellent film (F) has been separated, and a surface reforming member 170 for reforming the outer surface of the cleaned rotating belt 110.

The rotating belt 110 is for forming an uneven surface on the undersurface of the liquid polymer (M) supplied on the upper surface thereof, a strap with a pattern formed through metal plating or laser processing is electroformed with nickel (Ni), and plasma treatment with oxygen (O2), nitrogen (N2), air, or a fluorine-containing gas is performed under atmospheric pressure.

Accordingly, the outer surface of the rotating belt 110 aids in uniform diffusion of liquid polymer (M) when coming into contact with the liquid polymer (M), and lowers the hydrophilic properties of the liquid polymer (M) to facilitate separation of an ultra water repellent film (F) from the rotating belt 110.

Any type of liquid polymer having hydrophobic (water repellent) characteristics may be used as the liquid polymer (M), and includes ultraviolet fluorescent ingredients to prevent deterioration of ultraviolet rays.

Accordingly, the liquid polymer (M) is separated after contacting the uneven surface of the rotating belt 110, so that a surface of the liquid polymer (M) is given a surface texture of the corresponding surface of the rotating belt 110 to have ultra water repellency.

A hydrophilic liquid polymer may also be applied as the liquid polymer (M). If the liquid polymer (M) is hydrophilic, a hydrophobic member discharger 180 (described below) may selectively be operated to manufacture an ultra water repellent film (F).

A polymer supplying member 120 is installed upright on the left upper surface of the rotating belt 110. The polymer supplying member 120 has a hollow interior to receive the liquid polymer (M), and is provided with a nozzle 122 that decreases in sectional area progressively downward and is opened at the bottom.

Therefore, the polymer supplying member 120 is able to supply liquid polymer (M) stored within to the upper surface of the rotating belt 110 through the nozzle 122.

While not shown, a supply quantity controlling member may be provided on the nozzle 122 of the polymer supplying member 120 to control the quantity of supplied liquid polymer (M), and length of the nozzle 122 bottom from front to rear corresponds to the width of the ultra water repellent film (F) to be manufactured.

A thickness controlling member 130 is provided to the right of the polymer supplying member 120. The thickness controlling member 130 is a component that regulates liquid polymer (M) supplied by the polymer supplying member 120 to the upper surface of the rotating belt 110 to control the thickness of the polymer when the polymer moves to the right.

Accordingly, the thickness controlling member 130 may be configured to be capable of being moved upward/downward in accordance with the thickness of ultra water repellent film (F) to be manufactured, in order to control the thickness of the liquid polymer (M) for the ultra water repellent film (F).

Also, in order to control the entire thickness of the liquid polymer (M) supplied to the upper surface of the rotating belt 110, the thickness controlling member 130 may be formed elongated from front to rear.

The above-mentioned polymer drying member 140 is provided at the right on the upper surface of the rotating belt 110. The polymer drying member 140 is for drying the liquid polymer (M) to form an ultra water repellent film (F), may employ a heater for drying, and may be configured to radiate ultraviolet (UV) rays to harden liquid polymer (M).

Also, when the polymer drying member 140 hardens liquid polymer (M), by controlling the hardening conditions through controlling the contraction rate of the liquid polymer (M), a film separating member 150 facilitates separation of the resulting ultra water repellent film (F).

The film separating member 150 is provided apart from and to the right of the rotating belt 110. The film separating member 150 rotates clockwise about its center to wind ultra water repellent film (F) as it passes the polymer drying member 140, and is controlled to rotate at a speed corresponding to the conveying speed of the rotating belt 110.

Accordingly, the ultra water repellent film (F), that is conveyed in a state attached to the outer surface of the rotating belt 110, is separated from the rotating belt 110 and wound around the outside of the film separating member 150 to be capable of being formed as a continuous sheet.

A rotating belt cleaning member 160 is provided at the center beneath the rotating member. The rotating belt cleaning member 160 is configured to remove contaminants from plasma that can be left on the outer surface of the rotating belt 110 that has been separated from the ultra water repellent film (F) by the film separating member 150, and may generate plasma or use a solvent to perform cleaning.

Accordingly, although the rotating belt 110 continuously rotates along the rollers 112, a high-quality ultra water repellent film (F) that is uniform and does not contain contaminants can be manufactured.

In further detail, a surface reforming member 170 is provided at the left on top of the rotating belt 110, separated from the polymer supplying member 120. The surface reforming member 170 is for reforming the top surface of the rotating belt 110 by generating and applying plasma thereto. By generating plasma under atmospheric pressure, separation of the ultra water repellent film (F) by the film separating member 150 can be facilitated.

A hydrophobic member discharger 180 is provided to the left of the film separating member 150. The hydrophobic member discharger 180 uses plasma under atmospheric pressure to discharge a hydrophobic member in an upward direction, and before the hydrophobic member discharged by the hydrophobic member discharger 180 is wound on the film separating member 150, it is attached to the undersurface of the ultra water repellent film (F).

Accordingly, even when the liquid polymer is made hydrophilic when manufacturing the ultra water repellent film (F) using the ultra water repellent film manufacturing equipment 100, manufacturing of ultra water repellent film (F) is made possible using the hydrophobic member discharger 180.

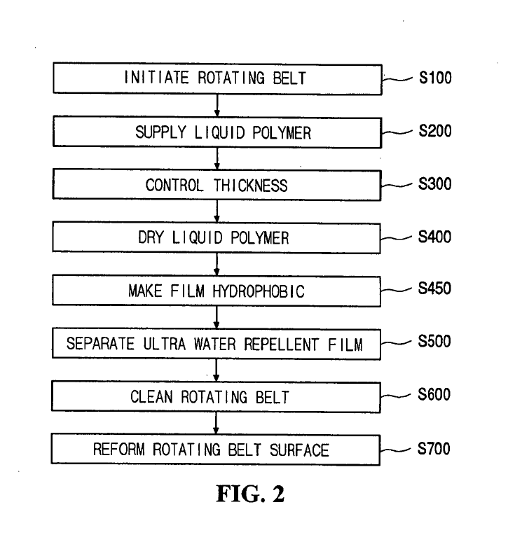

Below, a description of a manufacturing method using the above-configured ultra water repellent film manufacturing equipment will be provided with reference to FIG. 2.

In the case of the liquid polymer (M) being hydrophobic:

First, with liquid polymer (M) for manufacturing an ultra water repellent film introduced into polymer supplying member 120, the rollers 112 are rotated to put the rotating belt 110 into motion in a rotating belt initiation in operation S100.

At the same time, the polymer drying member 140, the film separating member 150, the rotating belt cleaning member 160, and the surface reforming member 170 are operated simultaneously.

After the rotating belt initiation in operation S100, a liquid polymer (M) held in the polymer supplying member 120 is supplied through the nozzle 122 to the upper surface of the rotating belt 110 in a liquid polymer supplying operation S200.

In further detail, before the upper surface of the rotating belt 110 is supplied with liquid polymer (M), the surface is cleaned of contaminants by the rotating belt cleaning member 160 and is reformed by the surface reforming member 170.

Then, the liquid polymer (M) supplied on the upper surface of the rotating belt 110 is controlled in thickness by the lower end of the thickness controlling member 130, to thin the thickness while moving to the right in a thickness controlling operation S300.

The liquid polymer (M) that is controlled in thickness in the thickness controlling operation S300 then passes below the polymer drying member 140 to be dried in a liquid polymer drying operation S400.

When the liquid polymer (M) is dried in the liquid polymer drying operation S400, its undersurface (the surface that contacts the upper surface of the rotating belt 110) has an uneven surface formed thereon that corresponds to the upper surface of the rotating belt 110.

Next, the ultra water repellent film (F) is wound around the outer periphery of the film separating member 150 and separated from the rotating belt 110 in an ultra water repellent film separating operation S500.

Then, when the lower surface of the rotating belt 110 (from which the ultra water repellent film (F) has been separated) moves to the left and passes the rotating belt cleaning member 160, a rotating belt cleaning operation S600 is performed to remove contaminants from the outer surface of the rotating belt 110.

After undergoing the rotating belt cleaning operation S600, the rotating belt 110 surface passes the surface reforming member 170, whereupon the surface undergoes a rotating belt surface reforming operation S700.

After all the above operations are performed in sequence, while the rotating belt 110 is being rotated, the rotating belt 110 is subjected to continuously repetition of the above operation sequence to enable continuous manufacturing of ultra water repellent film (F).

When the liquid polymer (M) is hydrophilic:

An ultra water repellent film manufacturing method has the same sequence as that for when the liquid polymer (M) is hydrophobic, except for that a film hydrophobic operation S450 is further provided between the liquid polymer drying operation S400 and the ultra water repellent film separating operation S500. In the film hydrophobic operation S450, the hydrophobic member discharger 180 is operated to discharge a hydrophobic member on the undersurface of the ultra water repellent film (F) that has completed the liquid polymer drying operation S400 to coat the undersurface.

Accordingly, when operation S450 of making the film hydrophobic is completed, the ultra water repellent film (F) having hydrophilic properties can be given hydrophobic properties.

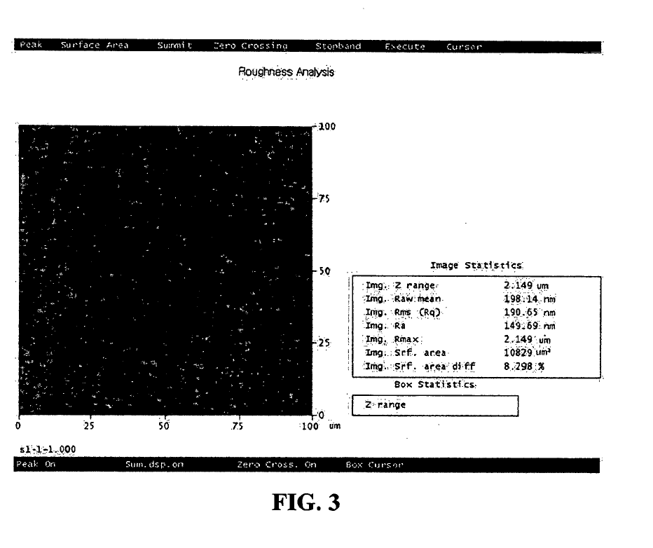

Described below are embodiments of ultra water repellent film manufacturing methods employing ultra water repellent film manufacturing equipment according to the present disclosure, with reference to FIGS. 3 to 7.

### FIRST EMBODIMENT

Metal plating is performed on a surface of the rotating belt 110 to form an uneven surface, and an atomic force microscope (AFM) result of the surface's uneven shape is shown in FIG. 3.

Referring to FIG. 3, the median unevenness of the rotating belt 110 surface is 150 nm, and the rotating belt 110 surface forms a contact angle of 120° with water droplets dropped thereon.

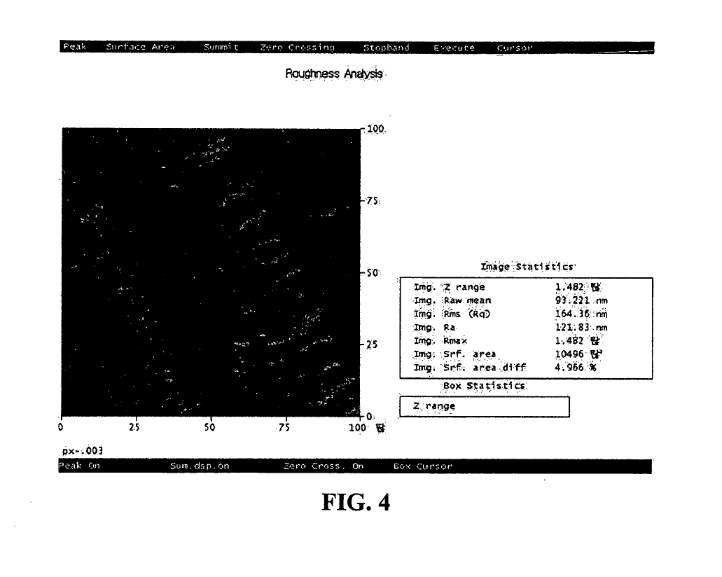

Also, the thickness of the median unevenness of an ultra water repellent film (F) manufactured with the ultra water repellent film manufacturing equipment 100 (to which the rotating belt 110 is applied) is 121 nm, as shown in FIG. 4, and when the ultra water repellent film (F) is separated from the metal plated surface, the surface of the ultra water repellent film (F) is stretched due to high cohesion between the contacting surfaces, and the stretched areas are displayed as white.

In addition, the surface of the ultra water repellent film (F) displayed a contact angle of 113° with water droplets dropped thereon.

### SECOND EMBODIMENT

After plasma under a vacuum or atmospheric pressure was generated on the metal plated surface of the rotating belt 110, oxygen gas (O2) was supplied to clean and activate the surface, after which the supplying of the O2 gas was ceased. Then, trifluoromethane gas (CHF3) that can coat hydrophobic material such as CF, CF2, and CF3, is supplied to treat and make the surface of the metal plated surface hydrophobic.

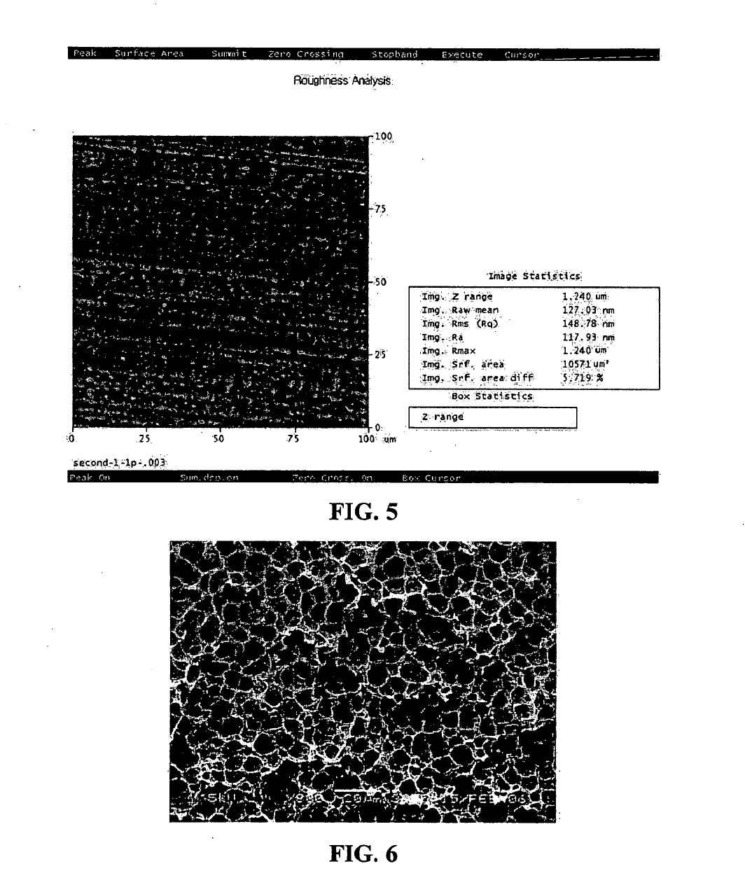

An AFM result of the surface shape of a thus-formed ultra water repellent film (F) is shown in FIG. 5.

That is, the surface of an ultra water repellent film (F) that has been manufactured with a plasma-treated rotating belt 110 can be seen as cleaner than one not manufactured with a plasma-treated rotating belt 110.

Thus, it is apparent that separating the ultra water repellent film (F) from the surface of the rotating belt 110 treated with plasma is easier than separating the ultra water repellent film (F) from a surface that has not been treated with plasma.

### THIRD EMBODIMENT

A Hyflon material was applied as the liquid polymer (M) to manufacture ultra water repellent film (F) according to an ultra water repellent film manufacturing method using ultra water repellent film manufacturing equipment.

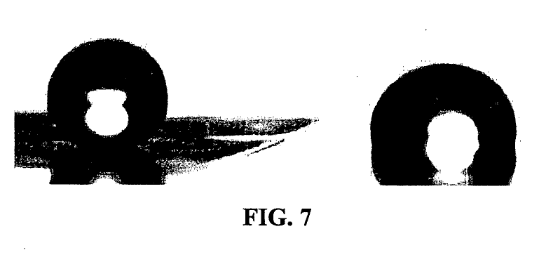

Here, the surface of the ultra water repellent film (F) was intagliated correspondingly with the surface shape of the rotating belt 110, as shown in FIG. 6.

Further, with respect to a measured contact angle of either surface of the ultra water repellent film (F) formed with Hyflon to water, the surface that contacted the surface of the rotating belt 110 displayed a contact angle of 150° or greater with water (as shown in FIG. 7), and the opposite surface that did not contact the surface of the rotating belt 110 displayed a contact angle of 90° with water.

Thus, it can be determined that a surface of the ultra water repellent film (F) that has been unevenly formed with the uneven surface of the rotating belt 110 has greater ultra water repellency than a surface that has not been formed in this manner.

In ultra water repellent film manufacturing equipment according to the present disclosure, when a liquid polymer is cast on and separated from an upper surface of a continuous belt, the liquid polymer supplied to the continuous belt can be controlled in thickness by a thickness controlling member.

Accordingly, a uniformly thick, high quality, ultra water repellent film can be continuously manufactured.

According to the above advantage, manufacturing cost can be reduced and yield can be increased.

In an ultra water repellent film manufacturing method employing ultra water repellent film manufacturing equipment according to the present disclosure, a rotating belt surface reforming process and a rotating belt cleaning process are performed to facilitate separation of ultra water repellent film from a rotating belt surface.

Thus, quality can be increased by preventing contaminants from infiltrating the ultra water repellent film and obviating the occurrence of separating defects that can occur through adhesiveness between the rotating belt surface and the ultra water repellent film.

Moreover, because an ultra water repellent film of a large surface area can be manufactured, the present disclosure can be effectively applied in an assorted number of fields.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. Equipment for manufacturing ultra water repellent film, comprising:
a rotating belt wound around outer peripheries of a plurality of rollers to continuously rotate;
a polymer supplying member for supplying a liquid polymer onto an upper surface of the rotating belt;
a thickness controlling member for controlling a thickness of the liquid polymer supplied onto the upper surface of the rotating belt;
a polymer drying member for drying the liquid polymer controlled in thickness;
a film separating member for separating an ultra water repellent film, formed through drying by the polymer drying member, from the rotating belt;
a rotating belt cleaning member for cleaning an outer surface of the rotating belt from which the ultra water repellent film has been separated; and
a surface reforming member for reforming the outer surface of the cleaned rotating belt.

2. The equipment according to claim 1, wherein the outer surface of the rotating belt is subjected to one or more of metal plating and plasma treatment and made into an uneven surface.

3. The equipment according to claim 1, wherein the polymer drying member is configured to apply heat to or radiate ultraviolet (UV) rays onto the liquid polymer.

4. The equipment according to claim 1, wherein the rotating belt cleaning member is configured to clean residual contaminants of polymer material from the outer surface of the rotating belt with plasma or solvent.

5. The equipment according to claim 1, wherein the surface reforming member generates plasma under atmospheric pressure and supplies the plasma onto the upper surface of the rotating belt.

6. The equipment according to claim 1, further comprising a hydrophobic member discharger provided between the polymer drying member and the film separating member, the hydrophobic member discharger using plasma to discharge a hydrophobic member on a surface of the ultra water repellent film when the liquid polymer is a hydrophilic member.

7. A method for manufacturing ultra water repellent film using equipment for manufacturing ultra water repellent film, the method comprising:
initializing rotation of a rotating belt having an uneven surface formed thereon;
supplying liquid polymer onto an upper surface of the rotating belt;
controlling a thickness of the liquid polymer supplied onto the upper surface of the rotating belt;
drying the liquid polymer that has been controlled in thickness in the controlling of the thickness;
separating an ultra water repellent film, formed from the drying of the liquid polymer, from the rotating belt;
cleaning by removing contaminants adhered to an outer surface of the rotating belt from which the ultra water repellent film has been separated; and
reforming the outer surface of the rotating belt through generating and supplying plasma thereon.

8. The method according to claim 7, wherein the drying of the liquid polymer comprises hardening the liquid polymer by applying heat thereto or radiating ultraviolet (UV) rays thereon.

9. The method according to claim 7, wherein the cleaning of the rotating belt comprises removing contaminants therefrom by generating and supplying plasma onto the rotating belt or passing the rotating belt through solvent.

10. The method according to claim 7, further comprising discharging a hydrophobic member between the drying of the liquid polymer and the separating of the ultra water repellent film, the discharging of the hydrophobic member using plasma under atmospheric pressure to discharge the hydrophobic member on a surface of a film having undergone the drying of the liquid polymer.
